(19) United States
(12) Patent Application Publication
(10) Pub. No.: US 2012/0183849 A1
(43) Pub. Date: Jul. 19, 2012

(54) NON-AQUEOUS ELECTROLYTE SECONDARY BATTERY

(76) Inventors: Shinsuke Matsuno, Tokyo (JP); Hiroki Inagaki, Kawasaki-shi (JP); Norio Takami, Yokohama-shi (JP)

(21) Appl. No.: 13/360,293

(22) Filed: Jan. 27, 2012

Related U.S. Application Data
(63) Continuation of application No. PCT/JP09/63575, filed on Jul. 30, 2009.

(51) Int. Cl. H01M 4/64; B82Y 30/00

(52) U.S. Cl. 429/211; 977/755

(57) ABSTRACT

According to one embodiment, a non-aqueous electrolyte secondary battery includes a positive electrode, a negative electrode spaced apart from the positive electrode, and a non-aqueous electrolytic solution. The negative electrode includes a collector, and a negative electrode layer formed on one or both surfaces of the collector and containing an active material having a potential of 0.5 V or more and 2 V or less based on metallic lithium at the insertion and the desorption of lithium. Metallic iron is formed on the surface of the negative electrode layer in an amount of 10 to 80% per unit area.

### CROSS REFERENCE TO RELATED APPLICATIONS

This application is a Continuation Application of PCT Application No. PCT/JP2009/063575, filed Jul. 30, 2009, the entire contents of which are incorporated herein by reference.

### FIELD

Embodiments described herein relate generally to a non-aqueous electrolyte secondary battery.

### BACKGROUND

In a non-aqueous electrolyte secondary battery, an organic film called SEI (Solid Electrolyte Interface) is formed on the surface of the negative electrode containing graphite as an active material. The organic film prevents direct contact between a non-aqueous electrolytic solution and the active material. As a result, continuous reaction between the active material and the non-aqueous electrolyte is inhibited.

On the other hand, little SEI is formed on the surface of the negative electrode containing a lithium titanium complex oxide as an active material. Therefore, the active material is always in direct contact with a non-aqueous electrolytic solution. As a result, a side reaction readily occurs between the active material and the non-aqueous electrolytic solution, and thus self discharge tends to occur.

### BRIEF DESCRIPTION OF THE DRAWINGS

FIG. 1 is a partial cross sectional view showing a non-aqueous electrolyte secondary battery (cylindrical non-aqueous electrolyte secondary battery) according to one embodiment;

FIG. 2 is a partially cutaway perspective view showing a non-aqueous electrolyte secondary battery (thin non-aqueous electrolyte secondary battery) according to one embodiment;

FIG. 3 shows XPS spectra obtained from the surface of the negative electrode layer of a sample taken from the negative electrode of Example 1; and

FIG. 4 is a digital camera photograph of the surface of the negative electrode layer of a sample taken from the negative electrode of Example 1.

### DETAILED DESCRIPTION

Hereinafter, the non-aqueous electrolyte battery according to the embodiments will be described.

In general, according to one embodiment, a non-aqueous electrolyte secondary battery comprises a positive electrode, a negative electrode spatially spaced from the positive electrode, and a non-aqueous electrolytic solution. The negative electrode comprises a collector, and a negative electrode layer formed on one or both surfaces of the collector and containing an active material having a potential of 0.5 V or more and 2 V or less based on metallic lithium at the insertion and the desorption of lithium. Metallic iron is formed on the surface of the negative electrode layer in an amount of 10 to 80% per unit area.

The negative electrode, positive electrode, and non-aqueous electrolytic solution are further described below.

1) Negative Electrode

The negative electrode comprises a collector and a negative electrode layer formed on one or both surfaces of the collector. The negative electrode layer contains an active material, a conductive agent, and a binder. The active material has a potential of 0.5 V or more and 2 V or less based on metallic lithium at the insertion and desorption of lithium. Metallic iron is formed on the negative electrode layer in an amount of 10 to 80% per unit area.

As described above, the metallic iron is formed on the negative electrode layer containing an active material (for example, a titanium complex oxide) having a potential of 0.5 V or more and 2 V or less based on metallic lithium at the insertion and desorption of lithium in an amount of 10 to 80% per unit area. Such the negative electrode can reduce the area of direct contact between the surface of the negative electrode layer and the non-aqueous electrolytic solution. As a result, the reaction between the titanium complex oxide contained in the negative electrode layer and the non-aqueous electrolytic solution is inhibited, and thus the non-aqueous electrolyte secondary battery including the negative electrode having a negative electrode layer has a low self discharge rate.

In order to achieve the same effect, the inventors formed a metal other than iron, such as nickel, manganese or cobalt on the surface of the negative electrode layer in an amount of 10 to 80% per unit area. However, the metal other than iron does not reduce but also increasing the self discharge. The reason why iron is effective is still unknown. As a result of a study carried out by the inventors, they have found that the metal other than iron exhibits a catalytic effect for promoting the reaction between the titanium complex oxide and the non-aqueous electrolytic solution, while iron is merely formed on the surface of the negative electrode layer to inhibit the reaction between the titanium complex oxide and the non-aqueous electrolytic solution, and does not act as an adverse factor.

Examples of the active material include an antimony intermetallic compound, lithium molybdenum oxide, and lithium lanthanum niobium oxide. Preferred active materials are lithium titanium complex oxides having a spinel crystal structure of titanium complex oxides, and the titanium dioxide (TiO₂ (B)) described in R. Marchand, L. Brohan, M. Tournoux, Material Resear Bulletin 15, 1129 (1980). The most preferred titanium oxide is spinel lithium titanium oxide having a composition of Li₄Ti₅O₁₂. These active materials have excellent cycling characteristics, and the combination of a titanium oxide and metallic iron can exhibit a great effect in reduction, of self-discharge.

If the amount of metallic iron formed on the surface of the negative electrode layer is less than 10% per unit area, reduction of self discharge will not be sufficiently achieved. On the other hand, if the amount of metallic iron formed on the surface of the negative electrode layer is more than 80% per unit area, diffusion of lithium ions is inhibited at the insertion and desorption of lithium into and from the negative electrode layer. As a result, the discharge performance and quick charge performance under a large current may be impaired. The amount of metallic iron formed on the surface of the negative electrode layer is more preferably from 30 to 70%, and even more preferably from 40 to 60% per unit area.

The formation of metallic iron on the surface of the negative electrode layer may be achieved by, for example, a method of using lithium iron phosphate as the active material of the positive electrode. When lithium iron phosphate is used as the active material of the positive electrode, a trace amount of water contained in the non-aqueous electrolyte secondary battery reacts with the lithium iron phosphate, and then iron ions are released from the positive electrode into the non-aqueous electrolytic solution. The released iron ions are diffused at the negative electrode side, and deposit on the surface of the negative electrode layer in the form of a metallic iron element (hereinafter referred to as metallic iron). The amount of deposit of metallic iron, more specifically the proportion of metallic iron formed on the surface of the negative electrode layer per unit area can be controlled by changing the conditions of aging treatment after preparation of the battery. The aging treatment is specifically carried out by adjusting the battery to a certain state of charge (SOC), and allowing it to stand at a certain temperature for a certain period of time.

Lithium iron phosphate is a substance whose main component has an olivine crystal structure and is expressed by a composition formula LiFePO₄. In order to impart electrical conductivity to LiFePO₄, the surface of the active material particles of the positive electrode may be coated with carbon, or the Fe in the crystal structure may be substituted with trace amount of metals. Further, in order to inhibit the surface reaction in the electrolytic solution and elsewhere, the surface of LiFePO₄ may be coated with various kinds of oxides such as MgO or ZrO₂.

In a form of a metallic iron formed on the surface of the negative electrode layer, the metallic iron is preferably formed in the state of sea regions and island regions. The island regions are coated with metallic iron, and the sea regions are uncoated with metallic iron. The sea regions serve as paths for diffusing lithium ions over the surface of the negative electrode layer, and thus allowing a good discharge performance and quick charge performance under a large current to be maintained. At the same time, the island regions block the contact between the surface of the negative electrode layer and the non-aqueous electrolytic solution, and thus effectively inhibit self discharge.

When metallic iron is formed on the surface of the negative electrode layer in the form of sea regions and island regions, the number of the sea regions having an area of 50 mm² or less is preferably one or more in a visual field of 4 cm² observed at a random position on the surface of the negative electrode layer. It is more preferred that the respective sea regions have an area of 0.1 mm² or more and 50 mm² or less. The number of the sea regions having such areas is preferably one or more and 75 or less in the visual field of 4 cm². It is even more preferred that 5 or more and 50 or less sea regions having an area of 0.1 mm² or more and 50 mm² or less are present in the visual field.

When a plurality of (preferably 5 to 75) sea regions are present in the visual field, the shortest distance between the sea regions having the above-described area is preferably from 0.1 to 5 mm.

In the island regions, the rate of diffusion of lithium ions is likely lower than that in the sea regions. Accordingly, for example, if the island regions and sea regions are unevenly distributed, lithium ions tend to be unevenly diffused. As a result, the regions of charge and discharge reaction occurring at the opposed positive electrode tend to be unevenly distributed, and thus the cycling characteristics may deteriorate. In addition, the uneven diffusion region of lithium may cause the deterioration in discharge performance and quick charge performance under a large current. Accordingly, the island and sea regions are preferably evenly distributed over the entire surface of the negative electrode layer.

In the metallic iron formed in the state of sea regions and island regions, the sea regions and island regions can be evenly distributed. As a result, good performance in the cycling characteristics, discharge performance and quick charge performance under a large current can be maintained. At the same time, as the points (island regions) blocking the contact between the surface of the negative electrode layer and the non-aqueous electrolytic solution are evenly distributed, a discharge is more effectively inhibited.

The island region preferably has a maximum height of 1 nm or more and 100 nm or less. The maximum height in this context is the height from the sea level to the peak of the island region, when the sea-like region uncoated with metallic iron (sea region) is regarded as the sea level. If the height of the island region is less than 1 nm, intended reduction of self discharge is hard to be achieved. On the other hand, if the height of the island region is more than 100 nm, metallic iron may penetrate the separator between the positive and negative electrodes to cause an internal short-circuit.

In metallic iron formed on the surface of the negative electrode layer in the form of sea regions and island regions, the island region most preferably has a protruding shape whose thickness gradually decreases from the island region toward the sea region.

When the thickness gradually decreases from the island region toward the sea region, more specifically, when the island region has a gentle slope toward the sea region, diffusion of lithium ions can occur not only in the sea region but also in the slope region, in which the thickness gradually decreases, for the surface of the negative electrode layer. As a result, better discharge performance and quick charge performance under a large current are maintained. On the other hand, when island regions having a certain thickness are formed on the surface of the negative electrode layer, and a plurality of sea regions (open regions where the negative electrode layer is exposed) are formed in the island regions, wherein the openings have a steep inner surface, in other words, there is no gentle inner surface equivalent to the horizon, paths for diffusing lithium ions occur only in the sea regions alone, and scarcely occur on the island regions around on the surface of the negative electrode layer.

Accordingly, in comparison with the former and latter sea-island structures of metallic iron, even if the areas of the sea regions are the same, the area of paths for diffusing lithium ions on the surface of the negative electrode layer can effectively be increased in the latter case wherein slope regions are present between the island and sea regions. As a result, better discharge performance and quick charge performance under a large current are maintained.

In the embodiment, it is a preferable that the negative electrode presents the maximum peak belong to metallic iron existed on the surface of the negative electrode layer in the range of 704 to 707 eV or 716 to 720 eV by an XPS spectrum measurement in the range of 700 eV or more and 730 eV or less.

As the conductive agent, normally a carbon material is used. A carbon material has high retentivity for alkali metals and high electrical conductivity. Examples of the carbon material include acetylene black and carbon black.

Examples of the binder include polytetrafluoroethylene (PTFE), polyvinylidene fluoride (PVdF), fluorine rubber, ethylene-butadiene rubber (SBR), polypropylene (PP), polyethylene (PE), and carboxymethyl cellulose (CMC).

The blending proportions of the negative electrode active substance, conductive agent, and binder are preferably from 70 to 95% by weight, from 0 to 25% by weight, and from 2 to 10% by weight, respectively.

2) Positive Electrode

The positive electrode comprises, for example, a collector and a positive electrode layer formed on one or both surfaces of the collector. The positive electrode layer contains an active material, a conductive agent, and a binder.

The active material may be lithium iron phosphate alone, or a mixture of lithium iron phosphate and various kinds of oxides, sulfide, lithium complex oxide, and lithium complex phosphate compound. Examples of the active material other than lithium iron phosphate include lithium manganese complex oxide (for example, LiMn₂O₄ or LiMnO₂), lithium nickel complex oxide (for example, LiNiO₂), lithium cobalt complex oxide (LiCoO₂), lithium nickel cobalt complex oxide (for example, LiNi₁₋ₓ, CoₓO₂, 0<x≦1), lithium manganese cobalt complex oxide (for example, LiMn₂₋ₓCoₓO₄, 0<x≦1), and lithium complex phosphate compounds (for example, LiMnₓFe₁₋ₓPO₄, 0<x≦1).

Examples of the conductive agent include acetylene black, carbon black, and graphite.

Examples of the binder include polytetrafluoroethylene (PTFE), polyvinylidene fluoride (PVdF), fluorine rubber, ethylene-butadiene rubber (SBR), polypropylene (PP), polyethylene (PE), and carboxymethyl cellulose (CMC).

The blending proportions of the active material, conductive agent, and binder are preferably from 80 to 95% by weight, from 3 to 20% by weight, and from 2 to 7% by weight, respectively.

3) Non-Aqueous Electrolyte

The non-aqueous electrolytic solution is prepared by dissolving an electrolyte in a non-aqueous solvent.

The non-aqueous solvent may be selected from known non-aqueous solvents used for lithium batteries. Examples of the non-aqueous solvent include circular carbonates such as ethylene carbonate (EC) and propylene carbonate (PC); and mixed solvents of a circular carbonate and a non-aqueous solvent whose viscosity is lower than that of the circular carbonate (hereinafter referred to as second solvent).

Examples of the second solvent include linear carbonates such as dimethyl carbonate, methylethyl carbonate, and diethyl carbonate; γ-butyrolactone, acetonitrile, methyl propionate, and ethyl propanoate; cyclic linear ethers such as tetrahydrofuran and 2-methyltetrahydrofuran; and linear ethers such as dimethoxyethane and diethoxyethane.

Examples of the electrolyte include alkali salts. In particular, lithium salts are preferred. Examples of the lithium salt include lithium hexafluorophosphate (LiPF₆), lithium tetrafluoroborate (LiBF₄), lithium hexafluoroarsenate (LiAsF₆), lithium perchlorate (LiC1O₄), and lithium trifluoromethanesulfonate (LiCF₃SO₃). In particular, lithium hexafluorophosphate (LiPF₆), lithium tetrafluoroborate (LiBF₄) are preferred. The electrolyte is preferably dissolved in a non-aqueous solvent in an amount of 0.5 to 2 mol/L.

The separator serves to prevent the contact between the positive electrode and negative electrode, and is composed of an insulating material. The separator has a shape which allows the movement of the electrolyte between the positive electrode and negative electrode. Specific examples of the separator include synthetic resin nonwoven fabric, polyethylene porous film, polypropylene porous film, and cellulose separators.

A specific structure of a non-aqueous electrolyte secondary battery according to one embodiment is described below with reference to the drawings.

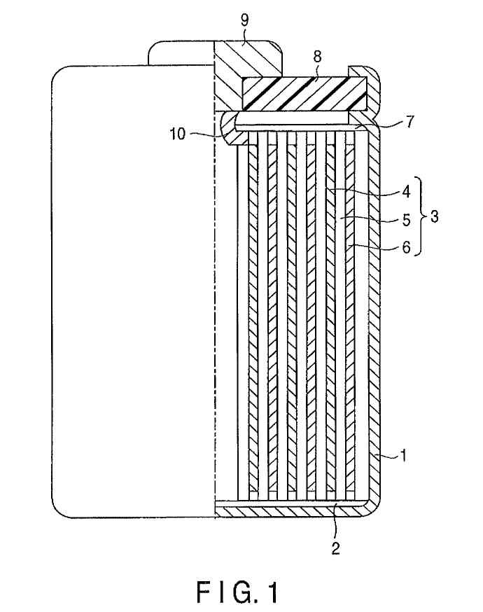

FIG. 1 is a partial cross sectional view showing a cylindrical non-aqueous electrolyte secondary battery. The closed-bottom cylindrical container 1 made of, for example, stainless steel which also serves as a negative electrode terminal has an insulator 2 on its bottom. An electrode group 3 is contained in the container 1. The electrode group 3 is made by spiraling a positive electrode 4 and a negative electrode 6 with a separator 5 sandwiched therebetween. The negative electrode 6 includes a collector (not shown) and negative electrode layers (not shown) formed on the both surfaces of the collector. The negative electrode layer contains an active material having a potential of 0.5 V or more and 2 V or less based on metallic lithium at the insertion and desorption of lithium, a conductive agent, and a binder. Metallic iron is formed on the surface of the negative electrode layers in an amount of 10 to 80% per unit area.

A non-aqueous electrolytic solution is contained in the container 1. An insulating paper sheet 7 having an open center is placed above the electrode group 3 in the container 1. An insulating sealing plate 8 is crimped onto the upper opening of the container 1. A positive electrode terminal 9 is engaged in the central portion of the insulating sealing plate 8. One end of a positive electrode lead 10 is connected to the positive electrode 4 and the other end is connected to the positive electrode terminal 9. The negative electrode 6 is connected to the container 1, which also serves as a negative electrode terminal, via a negative electrode lead (not shown).

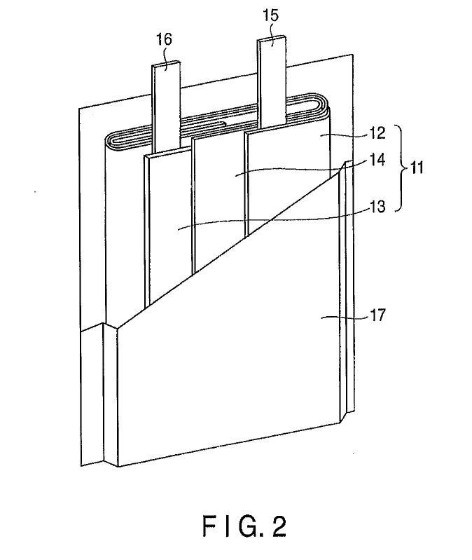

FIG. 2 is a partially cutaway perspective view showing a thin non-aqueous electrolyte secondary battery. A flat, spiral electrode group 11 is made by winding flatly a positive electrode 12 and a negative electrode 13 with a separator 14 sandwiched therebetween. The negative electrode 13 has the same structure as the negative electrode 6 described with reference to FIG. 1. A band-like positive electrode terminal 15 is electrically connected to the positive electrode 12. A band-like negative electrode terminal 16 is electrically connected to a negative electrode 13. The electrode group 11 is contained in a laminate package 17 with the ends of the positive electrode terminal 15 and the negative electrode terminal 16 extended from the package 17. The non-aqueous electrolytic solution is contained in the laminate package 17. The opening of the laminate package 17 is heat-sealed together with the positive electrode terminal 15 and the negative electrode terminal 16, thereby containing the electrode group 11 and non-aqueous electrolytic solution.

Examples of the embodiment are further described below.

### Example 1

### Making of Positive Electrode

Firstly, 91% by weight of lithium iron phosphate (LiFePO₄) powder as the active material, 2.5% by weight of acetylene black, 3% by weight of graphite, and 3.5% by weight of polyvinylidene fluoride (PVdF) were added to N-methylpyrrolidone, and mixed to obtain a slurry. The slurry was applied to an aluminum foil (collector) having a thickness of 15 μm, dried, and then pressed to obtain a positive electrode having positive electrode layers with a density of 2.5 g/cm³.

<Making of Negative Electrode>

Firstly, 85% by weight of spinel lithium titanium complex oxide (Li₄Ti₅O₁₂) powder, 5% by weight of graphite, 3% by weight of acetylene black, and 7% by weight of PVdF were added to NMP, and mixed to obtain a slurry. The slurry was applied to an aluminum foil (collector) having a thickness of 11 μm, dried, and then pressed to obtain a negative electrode having negative electrode layers with a density of 2.0 g/cm³.

<Making of Electrode Group>

The positive electrode, a separator made of polyethylene porous film, the negative electrode, and the separator were stacked in this order, wound in a spiral in such a manner that the negative electrode is positioned at the outermost layer, thus obtaining an electrode group.

<Preparation of Non-Aqueous Electrolytic Solution>

Ethylene carbonate (EC) and methylethyl carbonate (MEC) were mixed to give a volume ratio of 1:2, thus obtaining a mixed solvent. Lithium hexafluorophosphate (LiPF₆) was dissolved in the mixed solvent in an amount of 1.0 mol/L to obtain a non-aqueous electrolytic solution.

The electrode group and non-aqueous electrolytic solution were placed in a closed-bottom cylindrical container made of stainless steel. Subsequently, one end of the negative electrode lead was connected to the negative electrode of the electrode group, and the other end was connected to the closed-bottom cylindrical container which also serves as a negative electrode terminal. Subsequently, an insulating sealing plate having a positive electrode terminal fitted into the central portion was provided. One end of the positive electrode lead was connected to the positive electrode terminal, and the other end was connected to the positive electrode of the electrode group, and then the insulating sealing plate was crimped onto the upper opening of the container, thereby making a cylindrical non-aqueous electrolyte secondary battery which has the above-described structure shown in FIG. 1, and a capacity of 1.5 Ah.

The secondary battery thus obtained was charged at a 0.2 C rate, 25° C., and 2.4 V, and then discharged at a 0.2 C rate until the voltage reached 1 V. The cycle was repeated three times, and then charged at a 1 C rate such that the state of charge (SOC) was 50% (semi-charged). Thereafter, the battery was stored for a day at 80° C. with a SOC of 40% (aging treatment). After completion of aging, charge and discharge was repeated once at 25° C. and at a 1 C rate. The 1 C rate is the current value necessary for completely charging a unit cell in an hour. For convenience, the nominal capacity value of the unit cell may be replaced with the 1 C current value.

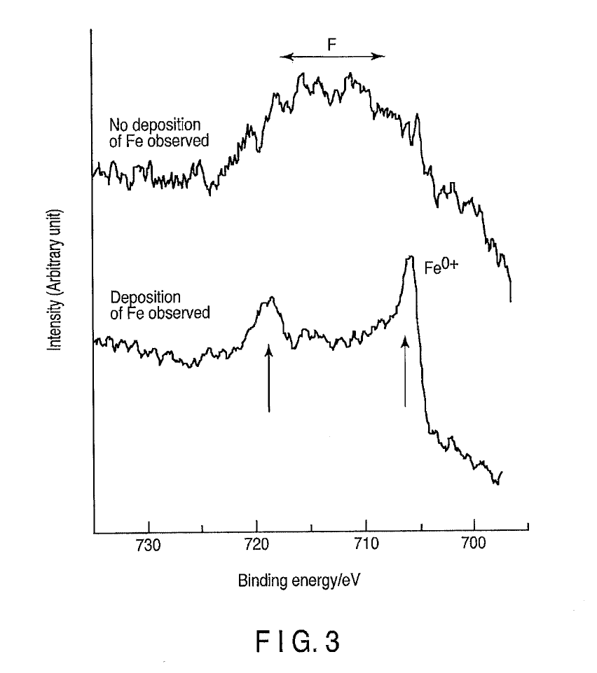

The secondary battery after the aging treatment was decomposed in an inert atmosphere, and the negative electrode having the negative electrode layers was extracted. One cm×1 cm square (1 cm²) pieces were randomly cut out from the negative electrode, and these samples were analyzed by XPS. As a result, peaks corresponding to metallic iron were found in the region from 700 to 730 eV. FIG. 3 shows typical XPS spectra of the samples. FIG. 3 shows XPS spectra of the samples without deposition of metallic iron in addition to those with deposition of the same. Even when the sample had no deposit of metallic iron, a broad peak was observed in the range of 710 to 720 eV, and this is because the influence of fluorine contained in the electrolytic solution could not be eliminated. When metallic iron apparently deposited on the surface of the negative electrode layer, peaks appeared at 705 eV and 718 eV. The peak positions slightly vary depending on the measurement conditions and measuring apparatus, but the maximum peak is observed in the range of at least one of approximately 704 to 707 eV and/or 716 to 720 eV.

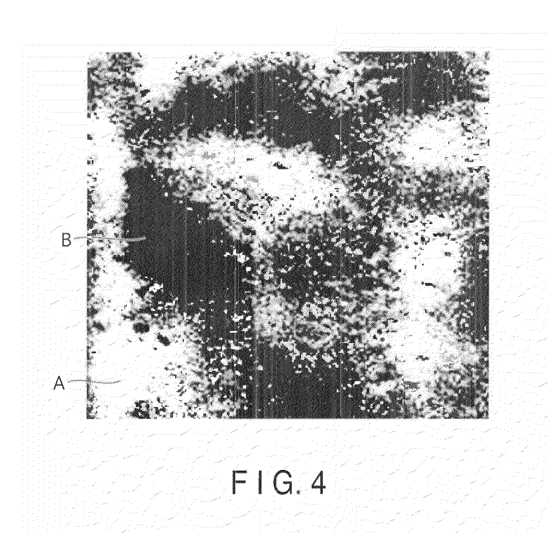

In addition, 2 cm×2 cm square (4 cm²) samples were randomly cut out from the negative electrode, and these samples were photographed with a digital camera. Of these photographs, a typical one is shown in FIG. 4. In FIG. 4, the region indicated with A is a sea region, and that indicated with B is an island region. Island regions protruding on the surface of the negative electrode layer and sea regions were found in the photograph. The surface was analyzed by Auger Electron spectroscopy (AES) in the island and surrounding regions. As a result, the presence of the Fe element was found in the island regions. The sea regions were cut out, and the surface was analyzed by Auger spectroscopy (AES) in the same manner. As a result, the Fe element was not higher than the limit of detection.

Using the photographs of 10 samples (visual field of 4 cm²), the area of the island regions relative to the total area (4 cm²) was calculated for each sample, and then the area coated with metallic iron was calculated. The areas coated with metallic iron for the respective samples were totaled, and the total was divided by 10 (number of samples), and further divided by 4 cm², thereby determining the area coated with metallic iron on the negative electrode layer of the negative electrode. As a result, the area coated with metallic iron was 51%.

Further, one photograph was randomly chosen from the 10 sample photographs (visual field of 4 cm²), the area of the sea regions was calculated, and the maximum and minimum areas were calculated. In addition, the number of the sea regions having areas between the maximum and minimum areas was calculated. As a result, the maximum and minimum areas were 44.3 mm² and 8.8 mm², respectively, and the number of the sea regions having areas between the maximum and minimum areas was 13.

Further, the height of the protruding island regions in the 10 sample photographs (visual field of 4 cm²) was measured by AES. As a result, the maximum height of the island region was 67 nm. In addition, presence of a slope region having gradual decrease of the height from the island regions toward the sea regions was observed.

### Examples 2 to 10

Secondary batteries were assembled in the same manner as in Example 1, except that the aging treatment listed in Table 1 was carried out. XPS, AES, and photographing of the negative electrode were carried out in the same manner as in Example 1. As a result, similar deposition of metallic iron on the negative electrode to that in Example 1 was observed. The proportion of metallic iron covering the surface of the negative electrode layer calculated in Example 1, the number of the regions uncoated with metallic iron, and the maximum height of the coated region are summarized in Table 1.

### Comparative Example 1

A non-aqueous electrolyte secondary battery was assembled in the same manner as in Example 1, except that a lithium cobalt oxide (LiCoO₂) was used as the active material of the positive electrode, and no aging treatment was carried out.

XPS, AES, and photographing of the negative electrode were carried out in the same manner as in Example 1. As a result, coating of the negative electrode with metallic iron was not higher than the limit of detection.

The secondary batteries obtained in Examples 1 to 10 and Comparative Example 1 were charged to 100% at a 1 C rate, and then stored at 45° C. for a month. Thereafter, the batteries were subjected to a discharge test at a 1 C rate at 25° C. without charging until the voltage reached 1 V, and the residual capacity of the battery was measured. The measured residual capacity of the battery was compared with the residual volume of the battery based on the discharge capacity at the predetermined rate of 1 C before storage, and the residual rate (%) was calculated.

The secondary batteries obtained in Examples 1 to 10 and Comparative Example 1 were charged to 100% at a 1 C rate, and then subjected to a discharge test (discharge test under a large current) at 1 C and 5 C rates until the voltage reached 1 V. The ratio of the capacity at a 5 C rate to that at a 1 C rate was calculated as the capacity retention rate (%). These results are shown in Table 2.

TABLE 1

| | Positive | | Proportion of area coated | Number of uncoated | |
|---|---|---|---|---|---|
| | electrode | | with metallic iron on the | regions (sea regions) | |
| | active | Aging | surface of negative | having an area of | Maximum height |
| | material | conditions | electrode layer (%) | 0.1 to 50 mm² | of island region |
| Example 1 | LiFePO₄ | 80° C. SOC 40% 1 day | 51% | 13 | 67 nm |
| Example 2 | LiFePO₄ | 60° C. SOC 50% 1 day | 10% | 6 | 23 nm |
| Example 3 | LiFePO₄ | 85° C. SOC 10% 2 days | 80% | 48 | 87 nm |
| Example 4 | LiFePO₄ | 75° C. SOC 40% 1 day | 32% | 21 | 60 nm |
| Example 5 | LiFePO₄ | 75° C. SOC 20% 1 day | 61% | 18 | 61 nm |
| Example 6 | LiFePO₄ | 75° C. SOC 10% 1.5 day | 73% | 25 | 68 nm |
| Example 7 | LiFePO₄ | 60° C. SOC 10% 2 days | 62% | 37 | 33 nm |
| Example 8 | LiFePO₄ | 85° C. SOC 10% 0.5 day | 74% | 7 | 82 nm |
| Example 9 | LiFePO₄ | 50° C. SOC 10% 3 days | 13% | 21 | 5 nm |
| Example 10 | LiFePO₄ | 90° C. SOC 25% 0.5 day | 78% | 8 | 98 nm |
| Comparative | LiCoO₂ | — | — | — | — |
| Example 1 | | | | | |

TABLE 2

| | Residual rate | Retention of |
|---|---|---|
| | (%) | 5C capacity (%) |
| Example 1 | 90 | 85 |
| Example 2 | 85 | 88 |
| Example 3 | 92 | 81 |
| Example 4 | 86 | 87 |
| Example 5 | 89 | 82 |
| Example 6 | 91 | 87 |
| Example 7 | 88 | 86 |
| Example 8 | 92 | 82 |
| Example 9 | 79 | 89 |
| Example 10 | 93 | 80 |
| Comparative | 69 | 90 |
| Example 1 | | |

As is evident from Tables 1 and 2, the non-aqueous electrolyte secondary batteries of Examples 1 to 10 showed that the batteries had a high residual rate of discharge capacity before and after the period of storage and maintained their discharge performance under a large current, in other words, had a significantly low self discharge rate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-aqueous electrolyte secondary battery comprising a positive electrode, a negative electrode spaced apart from the positive electrode, and a non-aqueous electrolytic solution,
wherein the negative electrode comprises a collector, and a negative electrode layer formed on one or both surfaces of the collector and containing an active material having a potential of 0.5 V or more and 2 V or less based on metallic lithium at the insertion and the desorption of lithium, and
metallic iron is formed on the surface of the negative electrode layer in an amount of 10 to 80% per unit area.

2. The battery of claim 1, wherein the active material is a titanium complex oxide.

3. The battery of claim 1, wherein the metallic iron is formed on the surface of the negative electrode layer in the form of sea regions and island regions, and the island regions are coated with metallic iron, and the seas regions are uncoated with metallic iron.

4. The battery of claim 3, wherein the number of the sea regions uncoated with metallic iron having an area of 50 mm² or less is one or more in a visual field of 4 cm² observed at a random position on the surface of the negative electrode layer.

5. The battery of claim 3, wherein the island region coated with metallic iron has a height of 1 nm or more and 100 nm or less.

6. The battery of claim 3, wherein the island region coated with metallic iron is protruding, and the thickness gradually decreases from the protruding island region coated with metallic iron toward the sea region uncoated with metallic iron.

7. The battery of claim 1, wherein the negative electrode presents the maximum peak belong to metallic iron existed on the surface of the negative electrode layer in the range of 704 to 707 eV or 716 to 720 eV by an XPS spectrum measurement in the range of 700 eV or more and 730 eV or less.
